(19) United States
(12) Patent Application Publication
(10) Pub. No.: US 2025/0071873 A1
(43) Pub. Date: Feb. 27, 2025

(54) LIGHT STRIP AND LIGHT SPRING CONTROL METHOD, ELECTRONIC DEVICE, AND STORAGE MEDIUM

(71) Applicant: Shenzhen Oceanwing Smart Innovations Technology Co., Ltd., Shenzhen (CN)

(72) Inventors: Jia Liu, Shenzhen (CN); Zechao he, Shenzhen (CN)

(21) Appl. No.: 18/811,952

(22) Filed: Aug. 22, 2024

(30) Foreign Application Priority Data
Aug. 22, 2023 (CN) 202311062199.6
Aug. 22, 2023 (CN) 202311064959.7

(51) Int. Cl. H05B 47/125; G06T 7/20; G06T 7/70; G06V 40/10; H05B 47/165

(52) U.S. Cl. CPC H05B 47/125; G06T 7/20; G06T 7/70; G06V 40/10; H05B 47/165; G06T 2207/30196

(57) ABSTRACT

Embodiments of the present application relate to methods for controlling a light strip or a light string including a plurality of beads, an electronic device, and a storage medium. The method includes obtaining pose information of a target user collected by a pose sensor; determining a user pose of the target user based on the obtained pose information; determining target lighting parameters based on the determined user pose, where the target lighting parameters are lighting parameters matching or corresponding to the determined user pose, and the target lighting parameters are used for indicating lighting of the plurality of beads; and controlling the plurality of beads according to the target lighting parameters. Illumination of the beads in the light strip can be controlled through user's pose information, thereby improving the flexibility and richness of bead control.

The present application claims priority to CN application Ser. Nos. 20/231,1062199.6 and 202311064959.7, both filed on Aug. 22, 2023, before the China National Intellectual Property Administration, which are incorporated herein by reference in its entirety.

### TECHNICAL FIELD

The present application relates to the field of control technology, in particular to methods, electronic devices, and a storage medium for controlling light strips and light strings.

### BACKGROUND

A light strip is a strip lighting fixture formed by connecting a plurality of beads in series through wires. During actual use, the light strips can be used in a straightened form or arranged into various shapes (such as star, square, and triangle, and the like). When using the light strips, to achieve more diverse effects, users may need the beads on the light strips to work asynchronously, for example, by using certain lighting and dynamic effects to control the beads in the strip. Currently, the lighting and dynamic effects of multiple beads in a light strip are usually fixed. For example, current beads often can only achieve different lighting and dynamic effects based on user presets, and the repetitive lighting and dynamic effects can easily lead to aesthetic fatigue for users.

Hence, improving the flexibility and richness of bead control is a technical problem worth addressing.

### SUMMARY

To solve some or all of the above technical problems, embodiments of the present application provide methods for controlling a light strip and a light string, an electronic device, and a storage medium.

In a first aspect, an embodiment of the present application provides a method for controlling a light strip, the light strip includes a plurality of beads, and the method includes:

obtaining pose information of a target user collected by a pose sensor;

determining a user pose of the target user based on the pose information;

determining target lighting parameters based on the user pose, where the target lighting parameters are lighting parameters corresponds to the user pose, and the target lighting parameters are used for indicating lighting of the plurality of beads; and

controlling the plurality of beads according to the target lighting parameters.

In a second aspect, an embodiment of the present application provides an electronic device, including:

a memory, configured to store a computer program; and

a processor, configured to execute the computer program stored in the memory, where when the computer program is executed, the method in any embodiment of the method for controlling a light strip in the first aspect of the present application is implemented.

In a third aspect, an embodiment of the present application provides a computer-readable storage medium, storing a computer program, where when the computer program is executed by a processor, the method in any embodiment of the method for controlling a light strip in the first aspect of the present application is implemented.

In a fourth aspect, an embodiment of the present application provides a computer program including computer-readable code, where the computer-readable code is run on a device, a processor in the device is enabled to implement the method in any embodiment of the method for controlling a light strip in the first aspect of the present application.

In a fifth aspect, an embodiment of the present application provides a method for controlling a light string, the light string includes a plurality of beads, and the method includes:

obtaining a user image of a target user captured by a camera apparatus;

determining pose information of the target user based on the user image, where the pose information represents a user pose of the target user in a shooting region of the camera apparatus;

determining target lighting parameters based on the pose information and target position information, where the target position information indicates relative positions between the shooting region and the plurality of beads, and the target lighting parameters are used for indicating lighting of the plurality of beads; and

controlling the plurality of beads respectively according to the target lighting parameters.

In a sixth aspect, an embodiment of the present application provides an electronic device, including:

a memory, configured to store a computer program; and

a processor, configured to execute the computer program stored in the memory, where when the computer program is executed, the method in any embodiment of the method for controlling a light string in the fifth aspect of the present application is implemented.

In a seventh aspect, an embodiment of the present application provides a computer-readable storage medium, storing a computer program, where when the computer program is executed by a processor, the method in any embodiment of the method for controlling a light string in the fifth aspect of the present application is implemented.

In an eighth aspect, an embodiment of the present application provides a computer program including computer-readable code, where the computer-readable code is run on a device, a processor in the device is enabled to implement the method in any embodiment of the method for controlling a light string in the fifth aspect of the present application.

According to the method for controlling a light strip provided in the embodiment of the present application, pose information of a target user collected by a pose sensor can be obtained to lower the collection cost of the pose information and reduce the power consumption of the device for collecting the pose information. Next, a user pose of the target user is determined based on the pose information, so as to recognize the user pose. Then, target lighting parameters are determined based on the user pose, where the target lighting parameters are lighting parameters corresponding to the user pose, and the target lighting parameters are used for indicating lighting of the plurality of beads. Finally, the plurality of beads are controlled according to the target lighting parameters, so as to automatically control the plurality of beads to light in a way that matches the user pose. Therefore, the flexibility and richness of bead control can be improved.

According to the method for controlling a light string provided in the embodiment of the present application, the light string includes a plurality of beads, and a user image of a target user captured by a camera apparatus is obtained for subsequently controlling the beads in the light string. Next, pose information of the target user is determined based on the user image, where the pose information represents a user pose of the target user in a shooting region of the camera apparatus, so as to recognize the user pose. Then, target lighting parameters are determined based on the pose information and target position information, where the target position information indicates relative positions between the shooting region and the plurality of beads, and the target lighting parameters are used for indicating lighting of the plurality of beads respectively, so as to determine relative positions between the target user and the beads. Finally, the plurality of beads are controlled respectively according to the target lighting parameters, so as to automatically control the plurality of beads to light in a way that matches the user pose relative to the beads. Therefore, the flexibility and richness of bead control can be improved.

### BRIEF DESCRIPTION OF THE DRAWINGS

The accompanying drawings herein are incorporated into the description and constitute a portion of the description, show embodiments consistent with the present invention, and are used together with the description for explaining the principle of the present invention.

In order to describe the technical solutions in the embodiments of the present invention or in the prior art more clearly, the following briefly introduces the accompanying drawings required for use in the description of the embodiments or the prior art. Apparently, those of ordinary skill in the art can derive other drawings from the accompanying drawings without any creative effort.

One or more embodiments are exemplified by the corresponding accompanying drawings. The exemplified descriptions do not constitute limitations on the embodiments. The elements with the same reference numerals in the accompanying drawings are denoted as similar elements. Unless otherwise stated, the accompanying drawings do not constitute proportional limitations.

FIG. 1 is a schematic flowchart of a method for controlling a light strip provided in an embodiment of the present application;

FIG. 2 is a schematic flowchart of another method for controlling a light strip provided in an embodiment of the present application;

FIG. 3 is a schematic flowchart of still another method for controlling a light strip provided in an embodiment of the present application;

FIG. 4 is a schematic structural diagram of an apparatus for controlling a light strip provided in an embodiment of the present application;

FIG. 5 is a schematic flowchart of a method for controlling a light string provided in an embodiment of the present application;

FIG. 6 is a schematic flowchart of another method for controlling a light string provided in an embodiment of the present application;

FIG. 7 is a schematic diagram of an application scenario of a method for controlling a light string provided in an embodiment of the present application;

FIG. 8 is a schematic diagram of another application scenario of a method for controlling a light string provided in an embodiment of the present application;

FIG. 9 is a schematic diagram of still another application scenario of a method for controlling a light string provided in an embodiment of the present application;

FIG. 10 is a schematic structural diagram of an apparatus for controlling a light string provided in an embodiment of the present application; and

FIG. 11 is a schematic structural diagram of an electronic device provided in an embodiment of the present application.

### DETAILED DESCRIPTION

Various exemplary embodiments of the present application are now described in detail with reference to the accompanying drawings. Apparently, the described embodiments are some of the embodiments of the present application, not all of them. It should be noted that, unless otherwise specified, relative arrangements of components and steps, expressions of figures, and numerical values described in the embodiments do not limit the scope of the present application.

Those skilled in the art can understand that the terms “first”, “second”, and the like in the embodiments of the present application are only used for distinguishing different objects such as steps, devices, or modules, and represent neither any specific technical meaning nor a logic sequence of them.

It should also be understood that in the embodiments, “a plurality of” may refer to two or more, and “at least one” may refer to one, two, or more.

It should also be understood that any component, data, or structure mentioned in the embodiments of the present application can generally be understood as one or more without explicit limitation or contrary inspiration provided by the context.

In addition, the term “and/or” in the present application is merely an association relationship for describing associated objects, and represents three relationships. For example, A and/or B may represent the following three cases: A exists alone, both A and B exist, and B exists alone. In addition, the character “/” in the present application generally indicates an “or” relationship between the associated objects.

It should also be understood that the description of each embodiment in the present application emphasizes the differences from other embodiments, and their same or similar parts can be referred to each other and will not be repeated one by one for the sake of simplicity.

The following description of at least one exemplary embodiment is actually illustrative only and definitely is not construed as any limitation on the present application and the application or use thereof.

Technologies, methods, and devices known by those of ordinary skill in relevant fields may not be discussed in detail, but in appropriate situations, the technologies, methods, and devices should be regarded as parts of the description.

It should be noted that similar reference numerals and letters represent similar terms in the following drawings, so once a term is defined in a drawing, further discussion on the term is not required in the follow-up drawings.

It should be noted that the embodiments in the present application and the features in the embodiments may be combined with each other on a non-conflict basis. For the convenience of understanding the embodiments of the present application, the present application will be described in detail below with reference to the accompanying drawings and in conjunction with embodiments. Apparently, the described embodiments are some of the embodiments of the present application, not all of them. Based on the embodiments of the present application, all other embodiments obtained by those skilled in the art without any creative effort shall fall within the scope of protection of the present application.

In addition, it should be noted that a user (such as a target user) described in the present application can be distinguished by a user identifier. For example, the user identifier may be a login account. In this scenario, if different persons use the same account to log in, the different persons can be considered as the same user; and if the same person logs in with different accounts, it can be considered that the same person logging in with different accounts is a different user. For example, in a state where a device is not logged in, a user identifier may be assigned based on a device identifier of the device. In this scenario, if different persons use devices with the same device identifier for operation, the different persons can be considered as the same user; and if the same person uses devices with different device identifiers for operation, it can be considered that the same person is a different user.

In order to solve the technical problem of how to improve the flexibility and richness of bead control, the present application provides a method for controlling a light strip, which can improve the flexibility and richness of bead control.

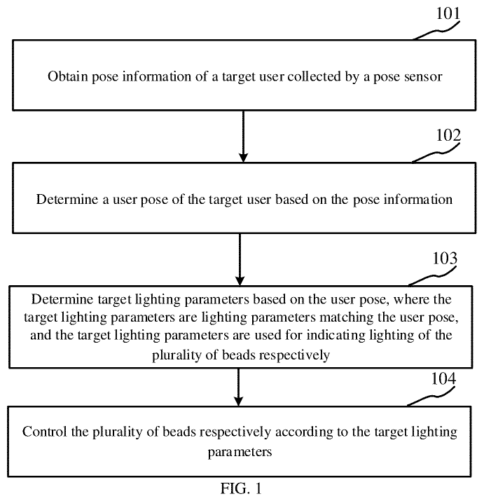

FIG. 1 is a schematic flowchart of a method for controlling a light strip provided in an embodiment of the present application. The light strip includes a plurality of beads.

The method can be applied to one or more electronic devices, such as lamp strips, smart phones, laptops, desktop computers, portable computers, and servers. In addition, the executive subject of the method may be hardware or software. When the executive subject is hardware, the executive subject may be one or more of the electronic devices. For example, a single electronic device can perform the method, or a plurality of electronic devices can cooperate with each other to perform the method. When the executive subject is software, the method can be implemented as a plurality of software programs or software modules, or as a single software program or software module. Specific limitations are not provided here.

As shown in FIG. 1, the method specifically includes:

Step 101: Obtain pose information of a target user collected by a pose sensor.

In this embodiment, the pose sensor can be used for distance detection (e.g., position detection) and angle detection (e.g., pose detection) of an object (including the target user).

In some cases, the pose sensor may be a 2D sensor. The 2D sensor may be a battery-powered sensor, which includes active transmitting and receiving devices and has a low-power standby mode (1D standby mode) and a working mode (2D working mode). For example, 2D millimeter wave radar is a sensor that detects a position region, presence or absence of an object, and a movement trajectory of the object by measuring the angle and distance of the target object relative to a reference position.

The 2D sensor, such as millimeter wave radar, calculates a distance between a target (such as the target user) and the radar by measuring round-trip time of signals. Specifically, the radar can transmit a beam of short pulse millimeter wave signals that can propagate in air. When the beam of signals encounters a target, some of the signals can be reflected back by the target. The radar can receive the reflected signals and measure the round-trip time of the signals, thereby calculating the distance between the target and the radar to achieve distance detection.

In addition, the 2D sensor, such as millimeter wave radar, can also calculate an angle of the target (such as the target user) by measuring a phase difference of signals. Specifically, the radar can transmit two adjacent millimeter wave signals with a phase difference. When the two signals encounter a target, the signals can be reflected back by the target and the phase difference between them can change. The radar receives the reflected signals and measures the change of the phase difference, thereby calculating the angle of the target to achieve angle detection.

By integrating distance and angle detection, the 2D sensor can achieve precise positioning and tracking of the target, thereby obtaining the aforementioned pose information.

The target user may be any user detected by the pose sensor.

Step 102: Determine a user pose of the target user based on the pose information.

In this embodiment, the pose information may represent at least one aspect of the user position, orientation and posture of the target user. Thus, a pose of the target user can be determined based on pose information, so as to obtain the user pose of the target user.

Step 103: Determine target lighting parameters based on the user pose, where the target lighting parameters are lighting parameters matching or corresponding to the user pose, and the target lighting parameters are used for indicating lighting of the plurality of beads respectively.

In this embodiment, a matching relationship or correspondence between a user pose and lighting parameters can be preset. Thus, lighting parameters matching the user pose can be determined based on the user pose obtained in step 102, so as to obtain the target lighting parameters.

Here, the light strip includes a plurality of beads. Therefore, different target lighting parameters can be determined for different beads, respectively. For example, if the light strip includes 3 beads, including bead A, bead B, and bead C, the target lighting parameters can indicate that the brightness of bead A is 0, the brightness of bead B is non-0, and the brightness of bead C is 0; or the target lighting parameters can indicate that the brightness of bead A is 0, the brightness of bead B is 50%, and the brightness of bead C is 100%; or the target lighting parameters can indicate that bead A emits red light, bead B emits yellow light, and bead C emits green light.

Step 104: Control the plurality of beads according to the target lighting parameters.

In this embodiment, because the target lighting parameters are used for indicating the lighting (e.g., light effect) of the plurality of beads respectively, the plurality of beads can be controlled respectively according to the target lighting parameters.

In some optional implementations of this embodiment, at least one of the following conditions can be used to determine the user pose of the target user based on the pose information:

In the first condition, a determination is made whether the target user is in a preset region based on the pose information.

The preset region may be one or more predetermined regions. The preset region may be located within a detection range of the pose sensor. Thus, after the pose sensor transmits signals, the receiving device determines whether signals of the target user reflected from the preset region are received, so as to determine whether the target user is in the preset region.

Here, the sensing range of the pose sensor can be virtualized into a plurality of sector regions based on distance and angle. Whether the object is a human body is determined by fitting the energy reflected by the human body to the pose sensor at different positions, or whether the object is a static object (such as pillar, sofa, or green plant, which has similar reflecting energy for a long time) or a human body (present for a short time) is determined by obtaining the presence time of the reflected object.

In the second condition, a position of the target user is determined based on the pose information.

Here, the pose sensor transmits a beam of signals (such as short pulse millimeter wave signals) that can propagate in air. When the beam of signals encounters a target (such as the target user), some of the signals can be reflected back by the target. The pose sensor can receive the reflected signals and measure round-trip time of the signals, so as to calculate a distance between the target and the pose sensor to determine the position of the target user.

In addition, the sensing range of the pose sensor can be first virtualized into a plurality of sector regions based on distance and angle, and a position region of the object can be determined by measuring the angle and distance of the object relative to a reference position.

In the third condition, a movement trajectory of the target user is determined based on the pose information.

Here, after the pose sensor continuously obtains positions of the target user, the movement trajectory of the target user can be determined based on the positions of the target user.

In addition, the sensing range of the pose sensor can be virtualized into a plurality of sector regions based on distance and angle, and a movement trajectory direction of the human body, such as left and right, far and near, can be obtained by obtaining different positions of a human body over a period of time.

Understandably, in the above optional implementations, at least one of whether the target user is in the preset region, the position of the target user, and the movement trajectory of the target user can be determined based on the pose information, so as to control the beads using different lighting parameters based on whether the target user is in the preset region or the determined position and movement trajectory of the target user, thereby further improving the flexibility and richness of control on the beads.

In some optional implementations of this embodiment, before the target lighting parameters are determined based on the user pose, relative positions between a detection range of the pose sensor and the plurality of beads can also be determined.

Specifically, after the pose sensor is installed, the detection range of the pose sensor and its relative position relationship with the light strip need to be marked. For example, the user can walk to mark sector detection regions of the pose sensor, including a leftmost point, a rightmost point, a farthest point, and a nearest point. An association relationship with the nearby light strip is marked simultaneously at each boundary point, such as bead xx of the light strip and flood light bead on the right side of the courtyard.

On this basis, the target lighting parameters can be determined based on the user pose by the following way:

determining the target lighting parameters based on the relative positions and the user pose.

Understandably, in the above optional implementation, the relative positions between the detection range of the pose sensor and the plurality of beads can be determined, and then the target lighting parameters can be determined based on the relative positions and the user pose, so as to control the beads, thereby improving the accuracy of bead control.

According to the method for controlling a light strip provided in the embodiment of the present application, pose information of a target user collected by a pose sensor can be obtained to lower the collection cost of the pose information and reduce the power consumption of the device for collecting the pose information. Next, a user pose of the target user is determined based on the pose information, so as to recognize the user pose. Then, target lighting parameters are determined based on the user pose, where the target lighting parameters are lighting parameters matching or corresponding to the user pose, and the target lighting parameters are used for indicating lighting of the plurality of beads respectively, so as to determine the lighting parameters matching the user pose. Finally, the plurality of beads are controlled respectively according to the target lighting parameters, so as to automatically control the plurality of beads to light in a way that matches or corresponds to the user pose. Therefore, the flexibility and richness of bead can be improved.

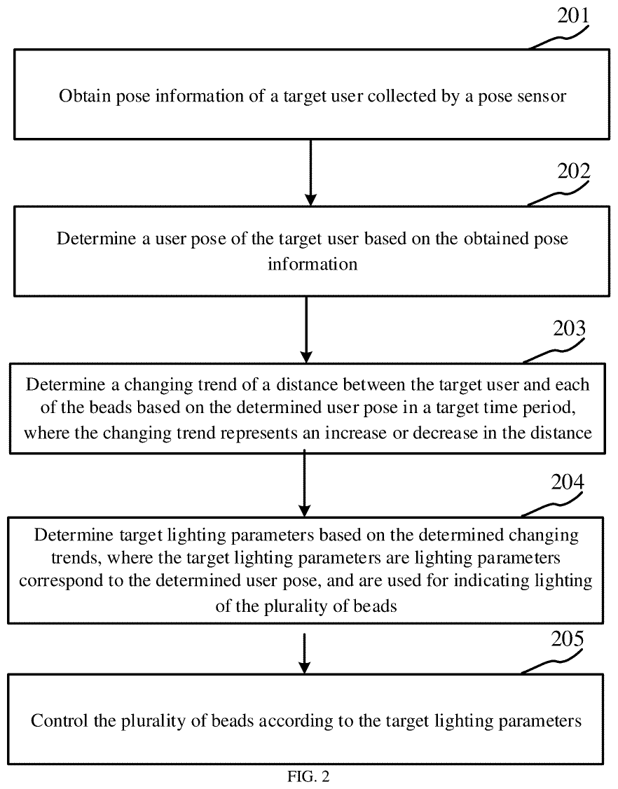

FIG. 2 is a schematic flowchart of another method for controlling a light strip provided in an embodiment of the present application. The light strip includes a plurality of beads. As shown in FIG. 2, the method specifically includes:

Step 201: Obtain pose information of a target user collected by a pose sensor.

In this embodiment, step 201 is substantially consistent with step 101 in the corresponding embodiment of FIG. 1, and will not be repeated here.

Step 202: Determine a user pose of the target user based on the pose information.

In this embodiment, step 202 is substantially consistent with step 102 in the corresponding embodiment of FIG. 1, and will not be repeated here.

Step 203: Determine a changing trend of a distance between the target user and each of the beads based on the user pose in a target time period, where the changing trend indicates an increase or decrease in the distance.

In this embodiment, if the target user walks towards the light strip, the distance between the target user and each of the beads will decrease; or if the target user walks in an opposite direction of the light strip, the distance between the target user and each of the beads will increase. If the target user walks in the opposite direction of the light strip and lingers at a certain position, the distance between the target user and each of the beads will alternatively increase and sometimes decrease.

Step 204: Determine target lighting parameters based on the determined changing trends, where the target lighting parameters are lighting parameters matching the user pose, and the target lighting parameters are used for indicating lighting of the plurality of beads respectively.

In this embodiment, matching relationships or the correspondence between various changing trends and lighting parameters can be preset, and then lighting parameters matching the changing trend determined in step 203 can be determined based on the matching relationships as lighting parameters matching the user pose, thereby obtaining the target lighting parameters.

Step 205: Control the plurality of beads respectively according to the target lighting parameters.

In this embodiment, step 205 is substantially consistent with step 104 in the corresponding embodiment of FIG. 1, and will not be repeated here.

In some optional implementations of this embodiment, the target lighting parameters can be determined based on the determined changing trend by the following way:

In the first way, after determining that changing trends associated with the plurality of the beads are the same, determining brightness of the plurality of beads based on at least one of: 1) the distances between the target user and each of the plurality of beads; and 2) the changing trends of the distance between the target user and each of the plurality of beads.

For example, the brightness of a bead may be negatively correlated with the distance between the bead and the target user. If the changing trends for the plurality of beads indicate an increase in distance, the brightness of the plurality of beads can gradually decrease; or if the changing trends for the plurality of beads indicate a decrease in distance, the brightness of the plurality of beads can gradually increase.

In the second way, after determining that the changing trends associated with the plurality of the beads are not the same, the target lighting parameter of a target bead is determined as a first parameter, and the target lighting parameter of non-target beads is determined as a second parameter.

The target bead is a bead, among the plurality of beads, at a distance less than or equal to a target distance from the position of the target user.

The target distance may be a predetermined distance. In addition, the target distance may alternatively be determined based on the distance between the positions of the target user.

For example, the target distance can be determined as follows: first, bead B that is closest to position A of the target user, and then the distance between bead B and position A is determined as the target distance.

For another example, the target distance can alternatively be determined as follows: three beads B, C, and D that are closest to position A of the target user are determined, then a bead (denoted as bead E) which is farthest from position A is determined, and the distance between bead E and position A is determined as the target distance.

For example, when a visitor walks left and right, the determined changing trends are not the same. In this case, the glowing bead lights up, following the visitor's position and displaying a first preset color (e.g., based on the first parameter, such as dark red), and the beads on two sides of the glowing bead display a second color (e.g., the second parameter, such as light red).

Understandably, in the above optional implementation, a target user's behavior of moving away from or moving towards the light strip or moving left and right along the light strip can be recognized, and then the plurality of beads are controlled using the corresponding target lighting parameters, thereby further improving the flexibility and richness of bead control.

In some application scenarios of the above optional implementation, the brightness represented by the first parameter is greater than the brightness represented by the second parameter.

For example, when the target user walks left and right, the determined changing trends are not the same. In this case, the point light source lights up following the visitor's position, the point light source closest to the visitor is the brightest, and the adjacent point light sources on the left and right dim gradually, thereby forming a focused following effect.

Understandably, in the above application scenario, when the target user moves left and right, that is, the determined changing trends are not the same, the position of the target user can be highlighted by controlling the brightness of the target bead to be greater than that of the other beads, thereby further enhancing user experience of ambient lighting.

Notably, in addition to the content described above, this embodiment may further include the corresponding technical features described in the embodiment corresponding to FIG. 1, thereby achieving the technical effects of the method for controlling a light strip shown in FIG. 1. Reference is made to the relevant description in FIG. 1 for details, which will not be repeated here for a brief description.

According to the method for controlling a light strip provided in the embodiment of the present application, a user trajectory can be obtained based on a user pose in a target time period. A changing trend of a distance between a target user and each bead is determined to recognize whether the user is moving close to or away from the light strip or moving along the light strip, and the plurality of beads are controlled using corresponding target lighting parameters, thereby further improving the flexibility and richness of bead control.

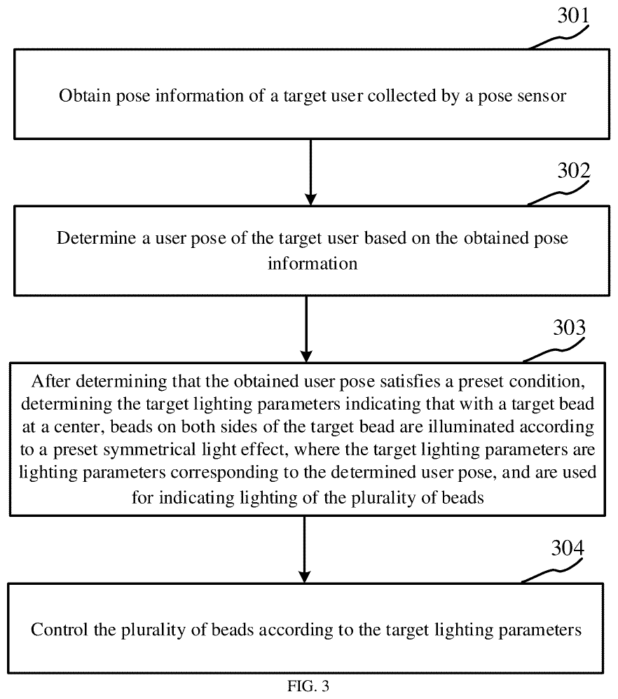

FIG. 3 is a schematic flowchart of still another method for controlling a light strip provided in an embodiment of the present application. The light strip includes a plurality of beads.

Specifically, as shown in FIG. 3, the method includes:

Step 301: Obtain pose information of a target user collected by a pose sensor.

In this embodiment, step 301 is substantially consistent with step 101 in the corresponding embodiment of FIG. 1, and will not be repeated here.

Step 302: Determine a user pose of the target user based on the pose information.

In this embodiment, step 302 is substantially consistent with step 102 in the corresponding embodiment of FIG. 1, and will not be repeated here.

Step 303: After determining that the user pose satisfies a preset condition, determine the target lighting parameters indicating that with a target bead at a center, beads on two sides of the target bead are illuminated according to a present symmetric light effect, where the target lighting parameters are lighting parameters matching or correspond to the user pose, and the target lighting parameters are used for indicating lighting of the plurality of beads respectively.

In this embodiment, the preset condition includes at least one of condition 1 and condition 2:

Condition 1: The user pose indicates that the target user is in a target region for a duration greater than or equal to a preset duration.

Condition 2: A time for collecting pose information of the user pose is within a preset time range. The preset time range may be a time period of the night. For example, the preset time range may be 22:00 to 5:00.

Here, the target bead is a bead, among the plurality of beads, at a distance less than or equal to a target distance from the position of the target user s. When a quantity of beads, among the plurality of beads, at the shortest distance from the position of the target user is greater than or equal to 2, the quantity of target beads may also be greater than or equal to 2.

For example, if the target user is in the target region for a duration greater than or equal to the preset duration, beads on two sides of the target bead can be controlled to light symmetrically according to a preset lighting effect, with the target bead as a center. For example, the target bead is illuminated, and the non-target beads are turned off. For example, if the brightness of the target bead is 100%, the brightness of the beads closer to the target bead is higher, and the brightness of the beads on two sides of the target bead is symmetrical. For another example, the target bead displays red, the two beads closest to the target bead display yellow, and the two beads next closest to the target bead display green.

For still another example, if the time for collecting the pose information is within the preset time range (such as 22:00-5:00), beads on two sides (such as left and right sides) of the target bead can be controlled to light symmetrically according to a preset lighting effect, with the target bead as a center. For example, the target bead is illuminated, and the non-target beads are turned off. For another example, if the brightness of the target bead is 100%, the brightness of the beads closer to the target bead is higher, and the brightness of the beads on two sides of the target bead is symmetrical. For another example, the target bead displays red, the two beads closest to the target bead display yellow, and the two beads next closest to the target bead display green.

For still another example, if the target user is in the target region for a duration greater than or equal to the preset duration and the time for collecting the pose information is within the preset time range (such as 22:00-5:00), beads on two sides of the target bead can be controlled to light symmetrically according to a preset lighting effect, with the target bead as a center. For example, the target bead is illuminated, and the non-target beads are turned off. For another example, if the brightness of the target bead is 100%, the brightness of the beads closer to the target bead is higher, and the brightness of the beads on two sides of the target bead is symmetrical. For another example, the target bead displays red, the two beads closest to the target bead display yellow, and the two beads next closest to the target bead display green.

In some optional implementations of this embodiment, the symmetrical lighting includes at least one of the following:

i. Lighting in order of distance from the target bead, from the farthest to the nearest.

For example, if the aforementioned light strip includes 5 beads, namely, bead A, bead B, bead C, bead D, and bead E and the target bead is bead C, bead A, bead C, and bead E are first controlled to be illuminated, and bead B and bead D are turned off; after a preset duration (such as 1 second), bead A and bead E are controlled to turn off, and bead B, bead C, and bead D are illuminated, so as to achieve a light effect flowing towards the target user.

ii. Lighting alternately in preset color sequence.

For example, if the aforementioned light strip includes 5 beads, namely, bead A, bead B, bead C, bead D, and bead E and the target bead is bead C, colors of bead A and bead E are first controlled to be blue, a color of bead C is white, and colors of bead B and bead Dare red; after a preset duration (such as 1 second), the colors of bead A and bead E are controlled to be red, the color of bead C is white, and the colors of bead B and bead D are blue, so as to achieve red-blue alternate lighting of left and right of the point light sources towards the target user.

Understandably, in the above application scenario, the plurality of beads are controlled to light symmetrically by the way described in at least one of i and ii above, which can further highlight the position of the target user, thereby enhancing user experience of ambient lighting.

Step 304: Control the plurality of beads respectively according to the target lighting parameters.

In this embodiment, step 304 is substantially consistent with step 104 in the corresponding embodiment of FIG. 1, and will not be repeated here.

Hereinafter, the pose sensor is a 2D sensor as an example for illustrating the embodiments of the present application. It should be noted that the embodiments of the present application can have the features described below, but the following description does not constitute limitations on the scope of protection of the embodiments of the present application.

In conventional systems, the lighting and dynamic effects of ambient lighting are usually fixed, different lighting and dynamic effects can be achieved only according to user presets; ambient interaction cannot be performed according to the presence, position, and movement trajectory of a user, and the repeated lighting effect easily leads to aesthetic fatigue.

In one embodiment of the present disclosure, the 2D sensor may be a battery-powered sensor, which includes active transmitting and receiving devices and has a low-power standby mode and a working mode. For example, 2D millimeter wave radar is a sensor that detects a position region, presence or absence of an object, and a movement trajectory of the object by measuring the angle and distance of the target object relative to a reference position.

The 2D sensor, such as millimeter wave radar, calculates a distance between a target and the radar by measuring round-trip time of signals. Specifically, the radar transmits a beam of short pulse millimeter wave signals that propagate in air. When the beam of signals encounters a target, some of the signals are reflected back by the target. The radar receives the reflected signals and measures the round-trip time of the signals, thereby calculating the distance between the target and the radar to achieve distance detection.

The 2D sensor, such as millimeter wave radar, calculates an angle of the target by measuring a phase difference of signals. Specifically, the radar transmits two adjacent millimeter wave signals with a phase difference. When the two signals encounter a target, the signals are reflected back by the target and the phase difference between them changes. The radar receives the reflected signals and measures the change of the phase difference, thereby calculating the angle of the target to achieve angle detection.

By integrating distance and angle detection, the 2D sensor can achieve precise positioning and tracking of the target.

In addition, the 2D sensor may have a 1D standby mode and a 2D working mode. In the 1D standby mode, the microwave transmitting pulse width is small (typical value 220 us), MCU (Microcontroller Unit) operation does not need to be activated, and the power consumption is low (typical value 2.88 mW), so the 1D standby mode is suitable for long-term low-power standby. In the 2D working mode, the microwave transmitting pulse width is large (typical value 1100 us), MCU operation needs to be activated, and the power consumption is high (typical value 49 mW), so the 2D working mode is used for short-term detection on the distance and angle of the target object.

The 2D sensor can switch from the 1D standby mode to the 2D working mode. After the sensor is powered on, the sensor defaults to enter the 1D standby mode. When an object is detected out in a working region and its reflection value is higher than a human body threshold, it is considered that a human body enters the working region or is continually present. At this time, the 2D sensor switches to the 2D working mode.

The 2D sensor can also switch from the 2D working mode to the 1D standby mode: when human body signals in the working region disappear for more than 1 second (default value), it is considered that the human body has left, and the 2D sensor switches to the 1D standby mode.

In this method, the 2D sensor can detect a position region (namely, the position of the target user), presence or absence (e.g., whether the target user is in a preset region), and a movement trajectory (e.g., the movement trajectory of the target user) of a visitor.

The 2D sensor can be powered by a battery, including AA, AAA, CR123A, a lithium battery, or other power supply solutions; and the user does not need to use a wire, so the mounting position is flexible and simple.

This method uses a 2D perception solution in which the distance of a target object (including the target user) is detected by active ToF (Time of Flight), and the angle of the target object is detected by a signal multi-transmitting and multi-receiving mechanism, thereby obtaining pose information of the target user.

During region detection, the sensing range of the 2D sensor can be first virtualized into a plurality of sector regions based on distance and angle, and a position region of the object can be determined by measuring the angle and distance of the object relative to a reference position.

During presence detection, the sensing range of the 2D sensor can be virtualized into a plurality of sector regions based on distance and angle. Whether the object is a human body is determined by fitting the energy reflected by the human body to the 2D sensor at different positions, or whether the object is a static object (such as pillar, sofa, or green plant, which has similar reflecting energy for a long time) or a human body (present for a short time) is determined by obtaining the presence time of the reflected object.

During trajectory tracking, the sensing range of the 2D sensor can be virtualized into a plurality of sector regions based on distance and angle, and a movement trajectory direction of the human body, such as left and right, far and near, can be obtained by obtaining the dwell time of the human body at different positions.

On this basis, the position region, presence or absence, and movement trajectory of the visitor can be obtained and linked with real-time changes in the lighting and dynamic effects of ambient lights.

1. Ambient lighting strip and controller:

a. An ambient lighting strip comes in various forms, including light strips, lawn lights, floodlights, wall-washing lights, and the like. They are characterized by having individually controllable light sources at each single point, including a plurality of beads.

b. The ambient lighting strip is connected to a controller by a unified wire and interface, and its lighting and dynamic effects are controlled by the controller.

c. The controller is wirelessly connected to a 2D sensor by Bluetooth or WiFi.

2. Initialization and calibration of the 2D sensor:

a. After installing the 2D sensor, the user may calibrate the detection range of the sensor and its relative position relationship with the ambient lighting strip.

b. The user walks to calibrate sector detection regions of the 2D sensor, including a leftmost point, a rightmost point, a farthest point, and a nearest point. An association relationship with the nearby smart light strip is marked simultaneously at each boundary point, such as light xx the light strip and flood light on the right side of the courtyard.

3. Lighting effect linkage:

a. Single point tracking: When a visitor moves close or away, the brightness of a single or three point light sources (namely, the aforementioned target bead) is adjusted according to the distance between the visitor and the light strip, that is, the point light sources light up when the visitor moving close and dim when the visitor moving away; when the visitor walks left and right, the glowing point light sources light up following the visitor's position, the point light source closest to the visitor is the brightest, and the adjacent point light sources on the left and right gradually become darker, thereby forming a focus following effect.

b. Bidirectional Highlight: When the visitor stays for more than a preset time (default 10 seconds), the point light source at the visitor's position is used as the center, and the left and right point light sources flow towards the visitor.

c. Late night warning: In a late night period (default 22:00-5:00), when the visitor stays for more than another preset time (default 30 seconds), the point light source at the visitor's position is used as the center, and the left and right point light sources alternately light in red and blue and flow towards the visitor.

In this method, the 2D sensor achieves interaction between the lighting effect and the visitor's walking trajectory, thereby enhancing visitor's pleasant feeling of ambient lighting. In addition, this method is simple and easy to use, does not need to install a wire or camera, and can be implemented by pasting a battery-powered outdoor sensor.

Notably, in addition to the content recorded above, this embodiment may further include the technical features described in the above embodiments, thereby achieving the technical effects of the method for controlling a light strip shown above. Reference is made to the above description for details, which will not be repeated here for a brief description.

According to the method for controlling a light strip provided in the embodiment of the present application, after the position of the target user is determined, with the target bead at the center, beads on two sides of the target bead can be controlled to light symmetrically according to a preset lighting effect to highlight the position of the target user, thereby improving user experience of ambient lighting.

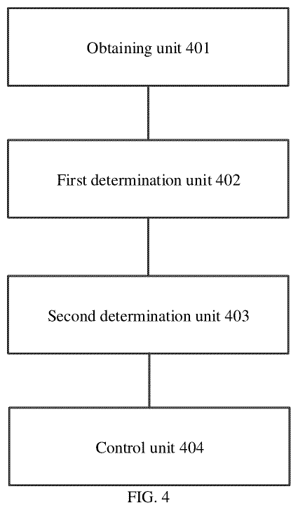

FIG. 4 is a schematic structural diagram of an apparatus for controlling a light strip provided in an embodiment of the present application. The light strip includes a plurality of beads, and the apparatus includes:

an obtaining unit 401, configured to obtain pose information of a target user collected by a pose sensor;

a first determination unit 402, configured to determine a user pose of the target user based on the pose information;

a second determination unit 403, configured to determine target lighting parameters based on the user pose, where the target lighting parameters are lighting parameters matching or corresponding to the user pose, and the target lighting parameters are used for indicating lighting of the plurality of beads respectively; and

a control unit 404, configured to control the plurality of beads respectively according to the target lighting parameters.

In one possible implementation, the determining a user pose of the target user based on the pose information includes at least one of the following: determining, based on the pose information, whether the target user is in a preset region; determining, based on the pose information, a position of the target user; and determining, based on the pose information, a movement trajectory of the target user.

In one possible implementation, the determining target lighting parameters based on the user pose includes: determining a changing trend of a distance between the target user and each of the plurality of beads based on the user pose in a target time period, where the changing trend indicates an increase or decrease in the distance; and

determining the target lighting parameters based on the determined changing trends.

In one possible implementation, after determining changing trends associated with the plurality of the beads are the same, the determining the target lighting parameters based on the determined changing trends includes: determining brightness of the plurality of beads based on at least one of: 1) the distance between the target user and each of the plurality of beads; and 2) the changing trends of the distance between the target user and each of the plurality of beads, to obtain the target lighting parameters; or after determining that the changing trends are not the same, determining the target lighting parameter of a target bead as a first parameter and the target lighting parameter of non-target beads as a second parameter, where the target bead is a bead, among the plurality of beads, at a distance less than or equal to a target distance from the position of the target user.

In one possible implementation, the brightness represented by the first parameter is greater than the brightness represented by the second parameter.

In one possible implementation, determining target lighting parameters based on the user pose includes:

after determining that the user pose satisfies a preset condition, determining the target lighting parameters indicating that with a target bead at a center, beads on both sides of the target bead are illuminated according to a symmetrical light effect, where the preset condition includes:

the user pose indicates that the target user is in a target region for a duration greater than or equal to a preset duration, and/or a time for collecting the pose information of the user pose is within a preset time range; and

where the target bead is a bead, among the plurality of beads, at a distance less than or equal to the target distance from the position of the target user.

In one possible implementation, the symmetrical lighting includes at least one of the following:

sequentially lighting up the beads in order from a farthest distance to a nearest distance from the target bead; and

alternatively lighting up the beads in a preset color sequence.

In one possible implementation, the apparatus further includes:

a third determination unit (not shown), configured to, prior to determining the target lighting parameters, determine relative positions between a detection range of the pose sensor and the plurality of beads; and

determining the target lighting parameters based on the relative positions and the user pose.

The apparatus for controlling a light strip provided in this embodiment may be the apparatus for controlling a light strip shown in FIG. 4, which can perform all steps of each above method for controlling a light strip, thereby achieving the technical effects of the method for controlling a light strip. Reference is made to the relevant description for details, which will not be repeated here for a brief description.

In order to solve the technical problem of how to improve the flexibility and richness of bead control in the conventional systems, the present application provides a method for controlling a light string, which can improve the flexibility and richness of bead control.

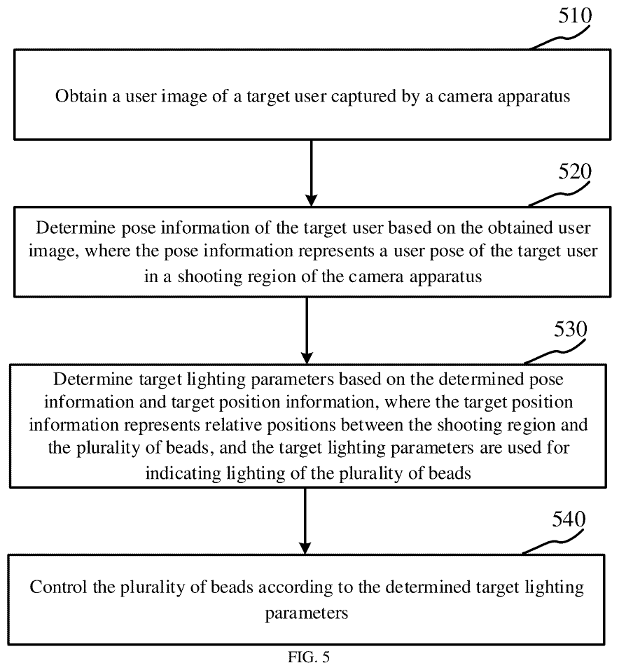

FIG. 5 is a schematic flowchart of a method for controlling a light string provided in an embodiment of the present application. The light string includes a plurality of beads.

The method can be applied to one or more electronic devices, such as lamp strings, smart phones, laptops, desktop computers, portable computers, and servers. The light string and the light strip are both strip lighting apparatuses with a plurality of beads. For the description of the light string, reference may be made to the previous description of the light strip, which will not be repeated here.

As shown in FIG. 5, the method specifically includes:

Step 510: Obtain a user image of a target user captured by a camera apparatus.

In this embodiment, the camera apparatus may be any one or more apparatuses with camera functions. For example, the camera apparatus may be a camera.

The target user may be any user detected by the camera apparatus.

The user image may be one or more images obtained by capturing, by the camera apparatus, a shooting region in which the target user is.

For example, when a user enters the shooting region of the camera apparatus and the camera apparatus captures the image of the shooting region, the user can be determined as the target user, and one or more images obtained by capturing the shooting region by the camera apparatus can be determined as the user image.

Moreover, in some cases, when the user image includes a plurality of images, the user image can represent a video of the target user.

The user image may be an image including user's face, body, or other biological features such as fingerprints and irises.

Step 520: Determine pose information of the target user based on the user image, where the pose information represents a user pose of the target user in a shooting region of the camera apparatus.

In this embodiment, the pose information may represent at least one of the position and posture of the target user in the shooting region of the camera apparatus. Moreover, in some cases, the pose information may further include an identity of a user corresponding to the pose information, such as whether the user is a family member, friend, stranger, or the like.

In some embodiments, the pose information can be obtained by a 2D sensor and a camera apparatus.

For example, image recognition can be performed on the user image captured by the camera apparatus to determine the pose information of the target user.

Here, the image recognition may include at least one of the following: face recognition, humanoid recognition, position detection, movement direction detection, human skeletal key point detection and behavior determination, gesture recognition, etc.

For the face recognition and humanoid recognition, the face recognition in a broad sense may include a series of related technologies for building a face recognition system, including face image capture, face localization, face recognition image pre-processing, identity confirmation, identity search, etc. The face recognition in a narrow sense specifically refers to a technology or system for confirming or searching an identity through a face.

The face recognition belongs to a biological feature recognition technology, which distinguishes individuals based on biological features of organisms (generally referring to humans). The biological feature recognition technology includes face, fingerprints, palm prints, iris, retina, body shape, personal habits (such as the intensity and frequency of keystrokes, and signature), etc. The corresponding recognition technologies include face recognition, fingerprint recognition, palm print recognition, iris recognition, retina recognition, body shape recognition, keyboard stroke recognition, signature recognition, etc.

Here, a person can be comprehensively recognized by face recognition, body shape recognition, and clothing color.

For the position detection: the camera (e.g., the aforementioned camera apparatus) can build its coordinate system to obtain a relative position of a moving object (such as the target user) in an image. Whether the moving object has entered a key position is further determined in conjunction with user's drawing of a home focus region and an interaction region in the coordinate system.

For the movement direction detection: the camera apparatus can be first fixed at an angle, coordinates of the moving object in each frame are tracked and counted, and a movement direction of the moving object, up, down, left, right, or other directions, can be obtained by calculation and combined with boundaries of a home region drawn by the user to determine whether the moving object is entering/leaving the home region, so as to further determine whether a person is currently passing by, returning home, or wandering around.

For the human skeletal key point detection and behavior determination: the detection on human skeletal key points can mainly be used for detecting some key points of the human body, such as joints, limbs, and five sense organs, and human posture information can be described through the key points. Due to the flexibility of the human body, various postures and shapes may appear, and any slight change in any part of the human body may create a new posture. Activities such as waving, punching, dancing, jumping, and falling are typical, which can be combined with the detection on human skeletal key points and tracking on activity change rules to determine the behavior of the current person.

In addition, the pose information of the target user can also be determined by the 2D sensor.

The description of the 2D sensor can refer to the description in the embodiment shown in FIG. 1, which will not be repeated here.

By integrating distance and angle detection, the 2D sensor can achieve precise positioning and tracking of the target, thereby obtaining the aforementioned pose information.

Step 530: Determine target lighting parameters based on the pose information and target position information, where the target position information indicates relative positions between the shooting region and the plurality of beads, and the target lighting parameters are used for indicating lighting of the plurality of beads respectively.

In this embodiment, matching relationships among the user pose, the target position information, and lighting parameters can be preset. Thus, based on the target position information and the user pose obtained in step 102, the lighting parameters matching the user pose and the target position information are determined, thereby obtaining the target lighting parameters.

Here, the light string includes a plurality of beads. Therefore, different target lighting parameters can be determined for different beads, respectively. For example, if the light string includes 3 beads, respectively bead A, bead B, and bead C, the target lighting parameters can indicate that the brightness of bead A is 0, the brightness of bead B is non-0, and the brightness of bead C is 0; or the target lighting parameters can indicate that the brightness of bead A is 0, the brightness of bead B is 50%, and the brightness of bead C is 100%; or the target lighting parameters can indicate that bead A emits red light, bead B emits yellow light, and bead C emits green light.

In this embodiment, differences in one or more of the face recognition results, humanoid recognition results, position detection results, movement direction detection results, human skeletal key point detection and behavior determination results, and gesture recognition results may, but do not necessarily, result in differences in the target lighting parameters.

Step 540: Control the plurality of beads respectively according to the target lighting parameters.

In this embodiment, because the target lighting parameters are used for indicating the lighting of the plurality of beads respectively, the plurality of beads can be controlled respectively according to the target lighting parameters.

The target lighting parameters can be used for indicating the color, brightness, color switching frequency, etc. of the beads.

In some optional implementations of this embodiment, at least one of the following is used to determine the pose information of the target user based on the user image:

i. Whether the target user is in a preset region is determined based on the user image, to obtain the pose information of the target user.

The pose information can represent whether the target user is in the preset region.

The preset region may be one or more predetermined regions. The preset region may be located within the shooting region of the camera apparatus. Thus, the camera apparatus captures an image of the shooting region to determine whether the target user is in the preset region.

ii. A position of the target user is determined based on the user image, to obtain the pose information of the target user.

The pose information can represent the position of the target user, such as the position of the target user in the shooting region.

iii. A movement trajectory of the target user is determined based on the user image, to obtain the pose information of the target user.

The pose information can indicate the movement trajectory of the target user.

Here, after the camera apparatus continuously obtains positions of the target user, the movement trajectory of the target user can be determined based on the positions of the target user.

iv. A behavioral intention of the target user is determined based on the user image, to obtain the pose information of the target user.

The pose information can represent the behavioral intention of the target user.

The behavioral intention may include at least one of the following: returning home, leaving home, singing, giving orders, dancing, inspiring, showing off, etc.

In practice, behavior recognition can be performed on the user image to determine the behavioral intention of the target user.

In some application scenarios of the above optional implementations, the following way can be used to determine target lighting parameters based on the pose information and the target position information:

First, a target bead and non-target beads are determined from the plurality of beads based on the pose information and the target position information.

The target bead is a bead, among the plurality of beads, at a distance less than or equal to a target distance from the position of the target user.

The target distance may be a predetermined distance. In addition, the target distance may alternatively be determined based on the distance between the position of the target user and the position of the bead.

Here, relative positions of the target user and the plurality of beads can be determined first through the pose information and the target position information. Further, a bead at a distance less than or equal to the target distance from the position of the target user, namely, the target bead, can be determined. And, among the plurality of beads, other beads except the target bead are determined as non-target beads.

For example, the target distance can be determined as follows: bead B closest to position A of the target user is first determined, and then the distance between bead B and position A is determined as the target distance.

For another example, the target distance can alternatively be determined as follows: three beads B, C, and D closest to position A of the target user are first determined, then a bead (denoted as bead E) farthest from position A is determined, and the distance between bead E and position A is determined as the target distance.

The non-target beads may be beads except the target bead among the plurality of beads.

Afterwards, the target lighting parameter of the target bead is determined as a first parameter, and the target lighting parameter of the non-target beads is determined as a second parameter.

For example, the first parameter can represent displaying the target bead in a first preset color (such as dark red), and the second parameter can represent displaying the non-target beads in a second color (such as light red).

Understandably, in the above application scenario, the beads closer to the target user can be controlled to display according to the first parameter, and the beads farther from the target user can be controlled to display according to the second parameter. In this way, the position of the target user can be highlighted by controlling the beads, thereby further improving the flexibility and richness of bead control.

In some cases of the above application scenario, when the first parameter indicates lighting state or illumination state of beads, the second parameter indicates turn-off state of other beads; or when the first parameter indicates turn-off of beads, the second parameter indicates lighting state of other beads.

Understandably, in the above situation, the position of the target user can be mapped to corresponding positions of the beads. For example, the beads wherever a person navigates to are turned on/off, and the remaining beads are turned off/on, to form a light following effect.

In some optional implementations of this embodiment, the following way can be used to determine target lighting parameters based on the pose information and target position information:

First, a distance that the target user moves in a preset direction is determined based on the pose information and the target position information, to obtain a movement distance.

The movement distance can represent the distance that the target user moves in the preset direction.

Here, after the camera apparatus continuously obtains positions of the target user, the position of the target user can be determined based the pose information and the target position information, thereby determining a movement trajectory of the target user.

Afterwards, a quotient between the movement distance and a preset distance threshold is determined.

In practice, the quotient between the movement distance and the preset distance threshold can be calculated in real time.

Finally, when an integer part of the quotient changes, the target lighting parameters are determined.

For example, a set of lighting parameters can be preset, where each lighting parameter in the set of lighting parameters can represent a color that the target user likes (such as a color set for the target user). Afterwards, when the integer part of the quotient changes, a lighting parameter can be randomly determined from the set of lighting parameters to obtain the target lighting parameter. Alternatively, when the integer part of the quotient changes, an unselected lighting parameter can be selected from the set of lighting parameters to obtain the target lighting parameter. When all the lighting parameters in the set of lighting parameters have been selected, each lighting parameter in the set of lighting parameters can be marked as unselected for subsequent selection.

Understandably, in the above optional implementation, a lighting parameter can be obtained every time the target user moves the preset distance threshold. Therefore, the flexibility and richness of control on the beads are further improved.

According to the method for controlling a light string provided in the embodiment of the present application, the light string includes a plurality of beads; a user image of a target user captured by a camera apparatus is obtained for subsequently controlling the beads in the light string. Next, pose information of the target user is determined based on the user image, where the pose information represents a user pose of the target user in a shooting region of the camera apparatus, so as to recognize the user pose. Then, target lighting parameters are determined based on the pose information and target position information, where the target position information indicates relative positions between the shooting region and the plurality of beads, and the target lighting parameters are used for indicating lighting of the plurality of beads respectively, so as to determine relative positions between the target user and the beads. Finally, the plurality of beads are controlled respectively according to the target lighting parameters, so as to automatically control the plurality of beads to light in a way that matches the user pose relative to the beads. Therefore, the flexibility and richness of bead control can be improved.

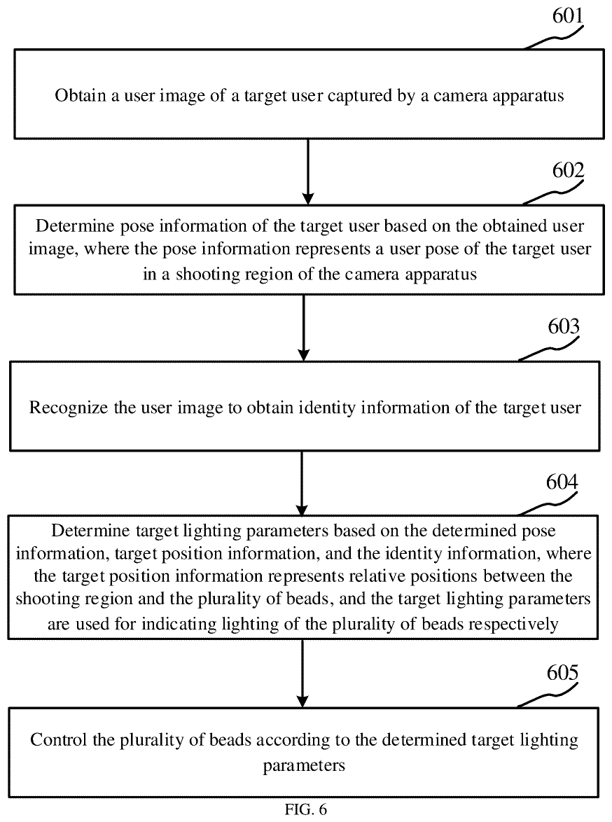

FIG. 6 is a schematic flowchart of another method for controlling a light string provided in an embodiment of the present application. The light string includes a plurality of beads. As shown in FIG. 6, the method specifically includes:

Step 601: Obtain a user image of a target user captured by a camera apparatus.

In this embodiment, step 601 is substantially consistent with step 510 in the corresponding embodiment of FIG. 5, and will not be repeated here.

Step 602: Determine pose information of the target user based on the user image, where the pose information represents a user pose of the target user in a shooting region of the camera apparatus.

In this embodiment, step 602 is substantially consistent with step 520 in the corresponding embodiment of FIG. 5, and will not be repeated here.

Step 603: Recognize the user image to obtain identity information of the target user.

In this embodiment, when the user image includes a face image, face recognition can be performed on the user image to obtain the identity information of the target user; when the user image includes a fingerprint image, fingerprint recognition can be performed on the fingerprint image to obtain the identity information of the target user; or when the user image includes an iris image, iris recognition can be performed on the user image to obtain the identity information of the target user.

The identity information can be used for indicating an identity of the target user.

Step 604: Determine target lighting parameters based on the pose information, target position information, and the identity information, where the target position information indicates relative positions between the shooting region and the plurality of beads, and the target lighting parameters are used for indicating lighting of the plurality of beads respectively.

In this embodiment, corresponding relationships among pose information, target position information, identity information, and lighting parameters can be preset, thereby determining lighting parameters matching the pose information determined in step 602 and the target position information based on the matching relationships as the target lighting parameters. Alternatively, corresponding relationships among user positions, identity information, and lighting parameters can be set, so that after a user position of the target user is determined based on the pose information and the target position information, lighting parameters matching the user position of the target user can be determined based on the matching relationships as the target lighting parameters.

Step 605: Control the plurality of beads respectively according to the target lighting parameters.

In this embodiment, step 605 is substantially consistent with step 540 in the corresponding embodiment of FIG. 5, and will not be repeated here.

In some optional implementations of this embodiment, the following way can be used to determine target lighting parameters based on the pose information, target position information, and the identity information:

First, whether the identity information indicates that the target user is a preset user is determined.

The preset user may include one of the following: family members and friends.

After determining that the identity information indicates that the target user is the preset user, to-be-displayed colors of the plurality of beads and switching time of the to-be-displayed colors are determined based on the pose information and the target position information, to obtain the target lighting parameters.

The target lighting parameters may include the to-be-displayed colors of the beads and the switching time of the to-be-displayed colors.

For example, a position, a moving path, and a moving speed of the target user can be determined first based on the pose information and the target position information. Afterwards, a next region that the target user will move into is determined from a predetermined set of regions based on the position and moving path of the user, to obtain a target region. Each region in the set of regions may correspond to a color. Time when the target user moves into the target region is determined based on the position, moving path, and moving speed of the target user are also determined. Then, the color corresponding to the target region is determined as a to-be-displayed color; and the time when the target user moves into the target region is determined as switching time of the to-be-displayed color.

For another example, a moving speed of the target user can be determined first based on the pose information and the target position information. Afterwards, a duration required for the target user to move a preset distance is determined based on the moving speed. The time at which the current time reaches the specified duration is determined as switching time of the to-be-displayed color. In this example, a set of colors also needs to be set. Afterwards, before the switching time arrives, a color can be randomly selected from the colors to obtain a target color. Alternatively, an unselected color is selected from the determined set of colors to obtain a target color. When all the colors in the set of colors have been selected, each color in the set of colors can be marked as unselected for subsequent selection.

Understandably, in the above optional implementation, to-be-displayed colors of beads and switching time of the to-be-displayed colors can be specifically determined by determining whether the target user is a preset user, thereby further improving the flexibility and richness of bead control.

Notably, in addition to the content described above, this embodiment may further include the corresponding technical features described in the embodiment corresponding to FIG. 1, thereby achieving the technical effects of the method for controlling a light string shown in FIG. 1. Reference is made to the relevant description in FIG. 1 for details, which will not be repeated here for a brief description.

According to the method for controlling a light string provided in the embodiment of the present application, target lighting parameters can be determined based on the identity information of the target user. In this way, the lighting effect presented by the beads can match the identity information of the target user, thereby further improving the flexibility and richness of bead control.

The following is an exemplary explanation of the embodiments of the present application. However, it should be noted that the embodiments of the present application may have the features described below, but the following description does not constitute limitations on the scope of protection of the embodiments of the present application.

Currently in the conventional systems, outdoor ambient lighting usually requires pre-setting of a lighting effect combination and cannot interact with people based on real-time situations. For example, when a family member returns home for birthday, the outdoor ambient light recognizes that she has switched the lighting effect. When gathering and playing on the outdoor lawn during holidays, children are playing games and want to increase the interactive atmosphere by using ambient lighting to accompany their activities.

Currently in the conventional systems, in order to interact with lights, additional hardware purchases are usually required. In this method of present disclosure, environmental perception can be achieved visually through a camera (e.g., the aforementioned camera apparatus). Therefore, this method combines the visual recognition and determination capabilities of indoor and outdoor ambient lights and cameras to determine the presence, position, and movement trajectory of a user, who she/he is, and her/his behavioral intentions, to perform ambient interaction and enrich lighting effects.

1. Usage scenario: Adding ambient lighting to everyday scenario can enhance enjoyment.

1) Light following interaction: Show off light following effect as a cool trick when friends come over.

The position of a moving object (namely, the target user) is mapped to the corresponding position of an ambient light (e.g., the light string), the ambient light is turned on/off to follow the location wherever the person goes, remaining lights are turned off/on, and their colors change, to create a light following effect.

In addition, it can also support light following effect according to a person's movement, or respond to hand gestures such as raising or waving a hand.

2) Grid trick interaction: Add to the festive atmosphere when children play games in the yard during holidays.

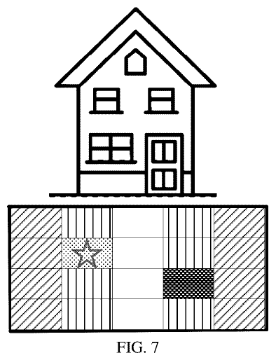

For example, FIG. 7 is a schematic diagram of an application scenario of a method for controlling a light string provided in an embodiment of the present application.

In FIG. 7, when a person is in different regions, different lighting effects (e.g., according to the aforementioned target lighting parameters) can be presented. One grid interaction color region may be drawn very large, or grid interaction color regions may be drawn for fine division one by one. In the figure, grids with different textures can correspond to different target lighting parameters, and grids with the same texture can correspond to the same target lighting parameters. The star in the figure can represent the position of a user (such as the target user).

3) Family interaction: change the scene when it is someone's birthday and the family member returns home, creating a dynamic atmosphere.

When the family member returns home, based on her preferences, her favorite light color is displayed following her steps when she gets closer to the doorstep.

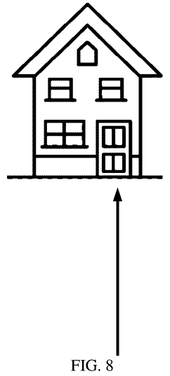

For example, FIG. 8 is a schematic diagram of an application scenario of yet another method for controlling a light string provided in an embodiment of the present application. In FIG. 8, when a family member (corresponding to the aforementioned target user) moves along a trajectory shown in the figure, her favorite light color is displayed following her steps when she gets closer to the doorstep.

4) Dance interaction: Enhance an atmosphere for the dance when friends dance in the yard.

For recreational scenarios such as dancing, if dancing activity is detected, the light automatically switches to a preset lively lighting effect.

5) In the future, based on user needs, there may be other AI (Artificial Intelligence) recognition and behavior detection algorithms that can be combined with lighting interaction to personalize the control on light strings.

2. Devices and capabilities included in an implementation solution:

This method includes a camera device such as a camera (e.g., the aforementioned camera apparatus), used with outdoor monochrome lights or an ambient light string such as RGB/RGBW/RGBWW.

The camera and the ambient light are interconnected by a technology such as local area networks, Bluetooth, or Matter, so as to send instructions processed by the camera to the ambient light.

1) Camera: It has advanced AI capabilities, and AI can run locally/in the cloud/both locally and in the cloud, and the AI algorithms include at least face recognition, humanoid recognition, wave detection, skeletal action behavior detection, walking direction detection, etc.

2) Light string: outdoor light string, indoor light strip, spotlights, Christmas lights, etc. The light string is not limited in form, but it has the ability to support single-point lighting effect control and segmented lighting effect control. And the ambient light is preset with a library storing a large quantity of interactive lighting effects, so that each subsequent action/intention can have matching interactive lighting effects.

3. Implementation process:

1) The user (such as the target user) performs region detection functions through a camera: building a visual map, drawing position division interaction regions, specifying event relationships, and specifying interaction methods. And it is recommended to specify a one-to-one corresponding control relationship between the visual map and actual physical ambient lights.

The user can preview camera images in real time, finely draw a single region/a plurality of regions (e.g., the preset region) in an editor, and specify a lighting effect control mode (changing light or following light) for a moving object (such as a person or a vehicle) in each region.

For example, the user can finely draw ground grids and specify a lighting effect corresponding to each grid when someone enters/exits.

For another example, the user can draw a walking path and specify a lighting effect corresponding to each walking distance in a walking direction.

User operation:

A large light interaction region is first drawn within the camera, for example, a home region is circled.

Light interaction regions are selected from the large interaction region, for example, block interaction or line interaction can be selected. The plurality of light interaction regions can be freely arranged and combined, or stacked and crossed. In addition, each region can be marked for visualization.

For the block interaction, color blocks are added and filled with colors to specify lighting effects. For the line interaction, moving lines are drawn to specify lighting effects. And it is recommended to set a one-to-one corresponding relationship between points on the moving lines and actual ambient lights, so as to achieve tracking control of light follow-up.

2) The user recognizes and detects AI capabilities through the camera: specifying which person and behavior to interact with.

Person specifying and person recognition: Family members and strangers can be specified, and there is no restriction on anyone. Information is obtained by camera-based face and humanoid recognition.

Behavior specifying and behavior recognition: Whether a person is walking, dancing, waving, etc. is determined based on camera detection on human skeleton and behavior determination. In addition, there is no restriction on any behavior.

Movement position detection: The camera records a movement region drawn by the user, and when someone appears, whether the person is in the region is determined.

Movement distance and movement direction tracking: The camera draws a movement trajectory of the moving person through the association of consecutive frames, and determines whether his walking direction matches the movement direction specified by the user.

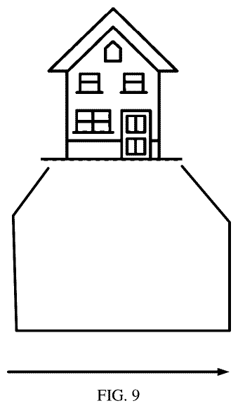

As an example, refer to FIG. 8 and FIG. 9. In the scenario shown in FIG. 8, it can be determined that the user's behavioral intention is to go home. In the scenario shown in FIG. 9, it can be determined that the user's behavioral intention is to pass by.

User operation:

A combination of person and behavior is selected, and then a specific lighting effect is specified.

Optionally, a combined response condition determination is made in conjunction with the region/walking direction set above.

3) The system recommends lighting effects matching user's intention based on user's first two selections. The user saves the lighting and dynamic effects as a preset interaction rule after confirmation.

Lighting effect library factors: Dynamic effects related to light following, waving, dancing, games, and children are preset. After the user completes the movement region and movement type selections of the first two steps, a back-end library recommends a combination of dynamic effects and light colors suitable for this scenario through semantic combination and understanding. The user can select or customize the corresponding lighting and dynamic effects.

For example, if the user selects waving for interaction, an AI big model understands an underlying intention, guessing that the user's intention might be to give orders, dance, try to inspire, or show off. It also understands that there might be a need for dynamic effects that are intense, fast and rhythmic. Dynamic effects with factors such as impact, flicker, forward movement, and diffusion among the lighting effect library factors are recommended to the user for selection. The user can directly select from existing dynamic effect recommendations, or finely tune or even fully customize the dynamic effects.

The light string has segmented and grouped control capabilities, which can correspond with the lighting effects one to one.

User operations include: selecting interaction behaviors, selecting recommended interaction lighting effects, confirming corresponding lighting relationships between lighting effects and the light string (segmented and grouped), and saving rules.

4) The camera determines interaction rules in real time and controls lighting changes of the light string: recognizing an object and its behavior in real time, receiving gestures/behavioral instructions from the moving object, and controlling the lights in real time.

After the camera completes recognition on the attribute, behavior, and instruction of the object in an image by using its computing power or cloud computing power, corresponding interaction lighting effect rules are triggered in conjunction with user-drawn positions and user-defined event rules and sent to ambient lights through wireless communication protocols such as local area networks/Bluetooth.

After receiving the instructions from the camera, the ambient lights play the specified lighting effects according to the rules, and complete interaction in response to the instructions of the moving object.

The camera relies on computing power and network connectivity. Based on user set region/linear/character behavior interaction lighting effects, when conditions change, the camera makes real-time response to achieve continuous real-time calculation and real-time light following changes, thereby ensuring long-term and timely interactive experience. For example:

Grid lighting effect interaction within a region: The camera calculates an intersection relationship between a specified object and a grid region in real time, and changes the specified object to a specified effect in real time.

Walking route interaction within a region: The camera calculates positions of a moving object in real time, and the positions correspond with preset interaction points of ambient lights one to one.

Character behavior interaction within a region: The camera recognizes frames one by one, determines changes in a subject in an image, and switches related effects.

In this method, the camera combined with visual AI can define precise interactions, the user is enabled to play with lights, rich lighting effects can be produced based on actual scenarios, and rich interactive lighting effects are achieved. The use of the camera and the visual technology in lighting interaction can achieve game style interaction based on human region and behavior response, thereby providing a bran-new method for controlling a light string. In addition, this method can also set a home interaction region and an interaction mode of interactive objects in real-time images through the camera. By understanding the intentions behind the computer vision behaviors chosen by users, corresponding lighting effects are recommended, and personalized lighting effect settings are achieved.

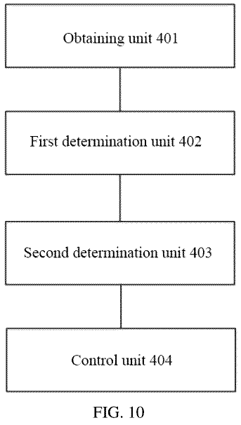

FIG. 10 is a schematic structural diagram of an apparatus for controlling a light string provided in an embodiment of the present application. The light string includes a plurality of beads, and the apparatus includes:

an obtaining unit 401, configured to obtain a user image of a target user captured by a camera apparatus;

a first determination unit 402, configured to determine pose information of the target user based on the user image, where the pose information represents a user pose of the target user in a shooting region of the camera apparatus;

a second determination unit 403, configured to determine target lighting parameters based on the pose information and target position information, where the target position information indicates relative positions between the shooting region and the plurality of beads, and the target lighting parameters are used for indicating lighting of the plurality of beads respectively; and

a control unit 404, configured to control the plurality of beads respectively according to the target lighting parameters.

In one possible implementation, the determining pose information of the target user based on the user image includes at least one of the following:

determining, based on the user image, whether the target user is in a preset region, to obtain the pose information of the target user;

determining, based on the user image, a position of the target user, to obtain the pose information of the target user;

determining, based on the user image, a movement trajectory of the target user, to obtain the pose information of the target user; and

determining, based on the user image, a behavioral intention of the target user, to obtain the pose information of the target user.

In one possible implementation, the determining target lighting parameters based on the pose information and target position information includes:

recognizing the user image to obtain identity information of the target user; and

determining the target lighting parameters based on the pose information, the target position information, and the identity information.

In one possible implementation, the determining the target lighting parameters based on the pose information, the target position information, and the identity information includes:

determining whether the identity information indicates that the target user is a preset user; and

after determining that the identity information indicates that the target user is the preset user, determining to-be-displayed colors of the plurality of beads and switching time of the to-be-displayed colors based on the pose information and the target position information, to obtain the target lighting parameters.

In one possible implementation, the determining target lighting parameters based on the pose information and target position information includes:

determining a target bead and non-target beads from the plurality of beads based on the pose information and the target position information, where the target bead is a bead, among the plurality of beads, at a distance less than or equal to a target distance from the position of the target user; and

determining the target lighting parameter of the target bead as a first parameter, and determining the target lighting parameter of the non-target beads as a second parameter.

In one possible implementation,

when the first parameter indicates lighting state of the target bead, the second parameter indicates turn-off state of the non-target beads; or

when the first parameter indicates turn-off state of the target bead, the second parameter indicates lighting state of the non-target beads.

In one possible implementation, the determining target lighting parameters based on the pose information and target position information includes:

determining, based on the pose information and the target position information, a distance that the target user moves in a preset direction, to obtain a movement distance;

determining a quotient between the movement distance and a preset distance threshold; and

determining the target lighting parameters based on an integer part of the quotient after determining that an integer part of the quotient changes.

The apparatus for controlling a light string provided in this embodiment may be the apparatus for controlling a light string shown in FIG. 10, which can perform all steps of each above method for controlling a light string, thereby achieving the technical effects of the method for controlling a light string. Reference is made to the relevant description for details, which will not be repeated here for a brief description.

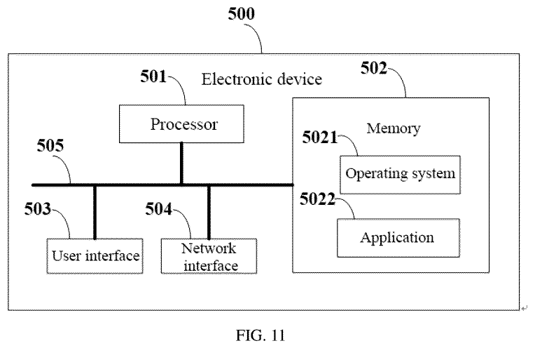

FIG. 11 is a schematic structural diagram of an electronic device provided in an embodiment of the present application. The electronic device 500 shown in FIG. 11 includes at least one processor 501, a memory 502, at least one network interface 504, and other user interfaces 503. Various components in the electronic device 500 are coupled together by a bus system 505. It may be understood that the bus system 505 is configured to implement connection and communication between the components. In addition to a data bus, the bus system 505 further includes a power bus, a control bus, and a status signal bus. However, for clarity of description, various buses are marked as the bus system 505 in FIG. 11.

The user interface 503 may include a display, a keyboard, or a click device (such as a mouse, a trackball, a touch panel, or a touchscreen).

It can be understood that the memory 502 in the embodiment of the present application may be a volatile memory or a non-volatile memory, or include both volatile and non-volatile memories. The non-volatile memory may be a read-only memory (ROM), a programmable read-only memory (PROM), an erasable PROM (EPROM), an electrically PROM (EEPROM), or a flash memory. The volatile memory may be a random access memory (RAM), which is used as an external cache. By way of example but not restrictive description, many forms of RAMs may be used, such as a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct Rambus RAM (DRRAM). The memory 502 described herein includes but is not limited to these memories and any other proper type of memories.

In some implementations, the memory 502 stores the following elements: an executable unit or a data structure, or subsets thereof, or extension sets thereof: an operating system 5021 and an application 5022.

The operating system 5021 includes various system programs, such as a framework layer, a core library layer, and a driver layer, for implementing various basic services and processing hardware-based tasks. The application 5022 includes various applications, such as a media player and a browser, which are used for implementing various application services. A program for implementing the methods in the embodiments of the present application may be included in the application 5022.

In one embodiment of the present application, by calling the program or instructions stored in the memory 502, specifically the program or instructions stored in the application 5022, the processor 501 is configured to perform the method steps provided in the above embodiments of the method for controlling a light strip.

In another embodiment of the present application, by calling the program or instructions stored in the memory 502, specifically the program or instructions stored in the application 5022, the processor 501 is configured to perform the method steps provided in the above embodiments of the method for controlling a light string.

The method disclosed in the above embodiments of the present application may be applied to the processor 501 or implemented by the processor 501. The processor 501 may be an integrated circuit chip having a signal processing capability. During implementation, the steps of the above method can be completed by hardware integrated logic circuits in the processor 501 or instructions in a form of software. The processor 501 may be a general-purpose processor, a digital signal processor (DSP), an application specific integrated circuit (ASIC), a field programmable gate array (FPGA), other programmable logic devices, discrete gate or transistor logic devices, or discrete hardware components. The processor can implement or perform the methods, steps, and logical block diagrams disclosed in the embodiments of the present application. The general-purpose processor may be a microprocessor, or the processor may be any conventional processor or the like. The steps of the method disclosed in the embodiments of the present application can be directly embodied as being performed by a hardware decoding processor, or performed by a combination of hardware and software units in the decoding processor. Software units may be located in a mature storage medium in the art, such as a random access memory, a flash memory, a read-only memory, a programmable read-only memory, an electrically erasable programmable memory, or a register. The storage medium is located in the memory 502, and the processor 501 reads information in the memory 502 and completes the steps of the above method in conjunction with its hardware.

It can be understood that the embodiments described herein may be implemented by hardware, software, firmware, middleware, microcode, or a combination thereof. For hardware implementation, the processing unit may be implemented in one or more application specific integrated circuits (ASICs), digital signal processing (DSP), DSP devices (DSPDs), programmable logic devices (PLDs), field-programmable gate arrays (FPGAs), general-purpose processors, controllers, microcontrollers, microprocessors, other electronic units for performing the above functions of the present application, or combinations thereof.

For software implementation, technologies described herein may be implemented through units that implement the above functions. Software code may be stored in the memory and executed by the processor. The memory may be implemented in or outside the processor.

The electronic device provided in this embodiment may be the electronic device shown in FIG. 11, which can perform all steps of each above method for controlling a light strip or a light string, thereby achieving the technical effects of the method for controlling a light strip or a light string. Reference is made to the relevant description for details, which will not be repeated here for a brief description.

An embodiment of the present application further provides a storage medium (computer-readable storage medium). The storage medium herein stores one or more programs. The storage medium may include a volatile memory, such as a random-access memory; the memory may also include a nonvolatile memory, such as a read-only memory, a flash memory, a hard disk drive, or a solid-state drive; and the memory may further include a combination of the above types of memories.

One or more programs in the storage medium can be executed by one or more processors to implement the method for controlling a light strip performed in the electronic device.

In one embodiment, the above processor is configured to execute a light strip control program stored in the memory to implement the following steps of the method for controlling a light strip performed in the electronic device:

obtaining pose information of a target user collected by a pose sensor;

determining a user pose of the target user based on the pose information;

determining target lighting parameters based on the user pose, where the target lighting parameters are lighting parameters matching or corresponding to the user pose, and the target lighting parameters are used for indicating lighting of the plurality of beads respectively; and

controlling the plurality of beads respectively according to the target lighting parameters.

In another embodiment, the above processor is configured to execute a light string control program stored in the memory to implement the following steps of the method for controlling a light string performed in the electronic device:

obtaining a user image of a target user captured by a camera apparatus;

determining pose information of the target user based on the user image, where the pose information represents a user pose of the target user in a shooting region of the camera apparatus;

determining target lighting parameters based on the pose information and target position information, where the target position information indicates relative positions between the shooting region and the plurality of beads, and the target lighting parameters are used for indicating lighting of the plurality of beads respectively; and

controlling the plurality of beads respectively according to the target lighting parameters.

A person skilled in the art may be further aware that the units and algorithm steps in the examples described in conjunction with the embodiments disclosed herein may be implemented by electronic hardware, computer software, or a combination thereof. To clearly describe the interchangeability between the hardware and the software, the foregoing has generally described compositions and steps of each example based on functions. Whether the functions are performed in a hardware or software manner depends on specific applications and design constraint conditions of the technical solutions. A person skilled in the art can use a different method for each specific application to implement the described functions, but the implementation is not beyond the scope of the present application.

The steps of the methods or algorithms described in the embodiments disclosed herein may be implemented by hardware, software modules executed by a processor, or a combination thereof. The software modules may be placed in an RAM, a memory, an ROM, an electrically programmable ROM, an electrically erasable programmable ROM, a register, a hard disk, a removable disk, a CD-ROM, or any other form of storage medium known in the art.

It should be understood that the terms used herein are only for the purpose of describing specific exemplary implementations and are not intended to be restrictive. Unless otherwise explicitly stated in the context, singular forms such as “a”, “one”, and “the” used herein may further include plural forms. The terms “comprise”, “include”, “contain”, and “have” are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

The above are merely specific implementations of the present invention, which enable those skilled in the art to understand or implement the present invention. Various modifications to the embodiments are obvious to those skilled in the art, and general principles defined herein can be implemented in other embodiments without departing from the spirit or scope of the present invention. Therefore, the present invention will not be limited to the embodiments described herein, but conforms to the widest scope consistent with the principle and novelty of the present application.

What is claimed is:

1. A method for controlling a light strip having a plurality of beads, and the method comprising:
obtaining pose information of a target user collected by a pose sensor;
determining a user pose of the target user based on the obtained pose information;
determining target lighting parameters based on the determined user pose, wherein the target lighting parameters correspond to the determined user pose, and are used for indicating lighting of the plurality of beads; and
controlling the plurality of beads according to the determined target lighting parameters.

2. The method according to claim 1, wherein the determining the user pose step comprises at least one of following:
determining, based on the determined pose information, whether the target user is in a preset region;
determining, based on the determined pose information, a position of the target user; and
determining, based on the determined pose information, a movement trajectory of the target user.

3. The method according to claim 1, wherein the determining the target lighting parameters step comprises:
determining a changing trend of a distance between the target user and each of the plurality of beads based on the determined user pose in a target time period, wherein the changing trend indicates an increase or decrease in the distance; and
the determining the target lighting parameters step is based on the determined changing trend.

4. The method according to claim 3, wherein the determining the target lighting parameters step comprises:
after determining changing trends associated with the plurality of the beads are same, determining brightness of the plurality of beads to obtain the target lighting parameters, wherein the determining the brightness is based on at least one of:
the distance between the target user and each of the plurality of beads; and
the changing trend of the distance between the target user and each of the plurality of beads; or
after determining the changing trends associated with the plurality of the beads are not same, determining a target lighting parameter of a target bead as a first parameter and a target lighting parameter of a non-target bead as a second parameter, wherein the target bead is a bead, among the plurality of beads, whose distance from a position of the target user is less than or equal to a target distance.

5. The method according to claim 4, wherein a brightness represented by the first parameter is greater than a brightness represented by the second parameter.

6. The method according to claim 1, wherein the determining the target lighting parameters step comprises:
after determining that the user pose satisfies a preset condition, determining the target lighting parameters indicating that with a target bead at a center, beads on both sides of the target bead are illuminated according to a preset symmetrical light effect, wherein the preset condition comprises: the user pose indicates that the target user is in a target region for a duration greater than or equal to a preset duration, and/or a time for collecting the pose information of the user pose is within a preset time range; and
wherein the target bead is a bead, among the plurality of beads, at a distance less than or equal to a target distance from a position of the target user.

7. The method according to claim 6, wherein the preset symmetrical light effect comprises at least one of following:
sequentially lighting up the beads in order from a farthest distance to a nearest distance from the target bead; and
alternatively lighting up the beads in a preset color sequence.

8. The method according to claim 1, wherein the determining the target lighting parameters step comprises:
prior to determining the target lighting parameters, determining relative positions between a detection range of the pose sensor and the plurality of beads; and
determining the target lighting parameters based on the relative positions and the user pose.

9. A method for controlling a light string having a plurality of beads, and the method comprising:
obtaining a user image of a target user captured by a camera apparatus;
determining pose information of the target user based on the obtained user image, wherein the pose information represents a user pose of the target user in a shooting region of the camera apparatus;
determining target lighting parameters based on the determined pose information and target position information, wherein the target position information indicates relative positions between the shooting region and the plurality of beads, and the target lighting parameters are used for indicating lighting of the plurality of beads; and
controlling the plurality of beads according to the determined target lighting parameters.

10. The method according to claim 9, wherein the determining the pose information step comprises at least one of following:
determining, based on the obtained user image, whether the target user is in a preset region, to obtain the pose information of the target user;
determining, based on the obtained user image, a position of the target user, to obtain the pose information of the target user;
determining, based on the obtained user image, a movement trajectory of the target user, to obtain the pose information of the target user; and
determining, based on the obtained user image, a behavioral intention of the target user, to obtain the pose information of the target user.

11. The method according to claim 9, wherein the determining the target lighting parameters step comprises:
recognizing the obtained user image to obtain identity information of the target user; and
determining the target lighting parameters based on the pose information, the target position information, and the identity information.

12. The method according to claim 11, wherein the determining the target lighting parameters based on the pose information, the target position information, and the identity information step comprises:
determining whether the identity information indicates that the target user is a preset user; and
after determining that the identity information indicates that the target user is the preset user, determining to-be-displayed colors of the plurality of beads and switching time of the to-be-displayed colors based on the pose information and the target position information, to obtain the target lighting parameters.

13. The method according to claim 9, wherein the determining the target lighting parameters step comprises:
determining a target bead and non-target beads from the plurality of beads based on the determined pose information and the target position information, wherein the target bead is a bead, among the plurality of beads, at a distance less than or equal to a target distance from a position of the target user; and
determining a target lighting parameter of the target bead as a first parameter, and determining a target lighting parameter of the non-target beads as a second parameter.

14. The method according to claim 13, wherein:
when the first parameter indicates a lighting state of the target bead, the second parameter indicates a turn-off state of the non-target beads; or
when the first parameter indicates the turn-off state of the target bead, the second parameter indicates the lighting state of the non-target beads.

15. The method according to claim 9, wherein the determining the target lighting parameters step comprises:
determining, based on the determined pose information and the target position information, a distance that the target user moves in a preset direction, to obtain a movement distance;
determining a quotient between the movement distance and a preset distance threshold; and
determining the target lighting parameters after determining that an integer part of the determined quotient changes.

16. An electronic device, comprising:
one or more processors, and
memory having executable instructions that, when executed by the one or more processors, cause the electronic device to:
obtain pose information of a target user collected by a pose sensor;
determine a user pose of the target user based on the obtained pose information;
determine target lighting parameters based on the determined user pose, wherein the target lighting parameters correspond to the determined user pose, and are used for indicating lighting of a plurality of beads on a light strip; and
control the plurality of beads according to the determined target lighting parameters.

17. The electronic device according to claim 16, wherein the instructions, when executed by the one or more processors, cause the electronic device to:
obtain a user image of the target user captured by a camera apparatus; and
determine the pose information of the target user based on the obtained user image, wherein the pose information represents the user pose of the target user in a shooting region of the camera apparatus,
wherein the determining target lighting parameters is further based on target position information indicating relative positions between the shooting region and the plurality of beads.

18. The electronic device according to claim 17, wherein the instructions, when executed by the one or more processors, cause the electronic device to determine the pose information of the target user by at least one of following:
determining, based on the obtained user image, whether the target user is in a preset region, to obtain the pose information of the target user;
determining, based on the obtained user image, a position of the target user, to obtain the pose information of the target user;
determining, based on the obtained user image, a movement trajectory of the target user, to obtain the pose information of the target user; and
determining, based on the obtained user image, a behavioral intention of the target user, to obtain the pose information of the target user.

19. The electronic device according to claim 17, wherein the instructions, when executed by the one or more processors, cause the electronic device to determine the pose information of the target user by:
recognizing the obtained user image to obtain identity information of the target user;
determining the target lighting parameters based on the pose information, the target position information, and the identity information;
determining whether the identity information indicates that the target user is a preset user; and
after determining that the identity information indicates that the target user is the preset user, determining to-be-displayed colors of the plurality of beads and switching time of the to-be-displayed colors based on the pose information and the target position information, to obtain the target lighting parameters.

20. A system comprising:
a light strip comprising a plurality of beads; and
a light strip control device coupled to the light strip to control the plurality of beads in the light strip,
wherein the light strip control device is configured to:
obtain pose information of a target user collected by a pose sensor,
determine a user pose of the target user based on the obtained pose information;
determine target lighting parameters based on the determined user pose, wherein the target lighting parameters correspond to the determined user pose, and are used for indicating lighting of the plurality of beads; and
control the plurality of beads according to the determined target lighting parameters.
